(19) United States
(12) Patent Application Publication
(10) Pub. No.: US 2004/0228497 A1
(43) Pub. Date: Nov. 18, 2004

(54) Multimedia car stereo system

(75) Inventor: Stephen Chen, Chang-Hua (TW)

Correspondence Address: BRUCE H. TROXELL, 5205 LEESBURG PIKE, SUITE 1404, FALLS CHURCH, VA, 22041, US

(73) Assignee: E-Lead Electronic Co., Ltd.

(21) Appl. No.: 10/438,832

(22) Filed: May 16, 2003

(51) Int. Cl. H04B 1/00; G06F 17/00; H04R 5/02

(52) U.S. Cl. 381/300; 700/94; 381/302; 381/307; 381/86

(57) ABSTRACT

A multimedia car stereo system and particularly to a multimedia car stereo system that has a center sound track source to match speakers installed at different locations that output sound to generate a surrounding sound effect. It mainly includes a front left speaker, a front right speaker, a rear left speaker, a rear right speaker, a center speaker and a matching car stereo host machine. The center speaker is located on the central control station at the front side of the car to provide the center sound track source. Mating the output sound from other speakers mounted on different locations, a surrounding sound effect like that in the theater may be achieved in the car.

### BACKGROUND OF THE INVENTION

1. Field of the Invention

The invention relates to a multimedia car stereo system and particularly to a multimedia car stereo system that has a central sound track source to match speakers installed at different locations that output the sound to generate a surrounding sound effect.

2. Description of the Prior Art

With continuous advances of electronic engineering, people demand higher output quality on audio systems. Audio systems have evolved from a single sound track and double sound tracks in the past to surrounding sound effect at present. The goal is to give people a sound effect like onsite listening. As the prices of the audio systems become more affordable, the concept of home theater also affects the car stereo system. A general car stereo system (as shown in FIG. 1) mainly includes a front left speaker 11, a front right speaker 12, a rear left speaker 13, a rear right speaker 14 and a matching car stereo host machine 10. While such a configuration can deliver a general sound effect, it cannot achieve the sound effect of a theater. Some venders try to add a higher power bass speaker in the rear trunk of the car (not shown in the drawing) to increase the sound effect of the base. Some even add an additional middle sound track speaker 15 on the front and right side of the car (on the foot pedal location in front of the passenger seat next to the driver seat) to simulate the sound effect of the theater. However such an arrangement has to modify the original wiring design and take consumes the limited car interior space. Moreover, alteration of the electric wiring often causes unstable operations of the car computers. It creates a potential risk for the car.

### SUMMARY OF THE INVENTION

In view of the aforesaid disadvantages, the invention aims at providing a multimedia car stereo system that has a center sound track source to remedy the problems of conventional car stereo systems such as not able to deliver theater sound effect, and car owners have to ask specialized audio shops to modify the car stereo systems. The multimedia car stereo system of the invention mainly includes a front left speaker, a front right speaker, a rear left speaker, a rear right speaker, a center speaker and a matching car stereo host machine. The main feature of the invention is that the center speaker is located on the central control station at the front side of the car to provide a center sound track source. Mating the sound output from other speakers mounted on the different locations, a surrounding sound effect may be achieved. It does not take extra interior space of the car. And car owners do not have to modify the existing stereo system to enjoy the surrounding sound effect like in the theater.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a modified conventional car stereo system.

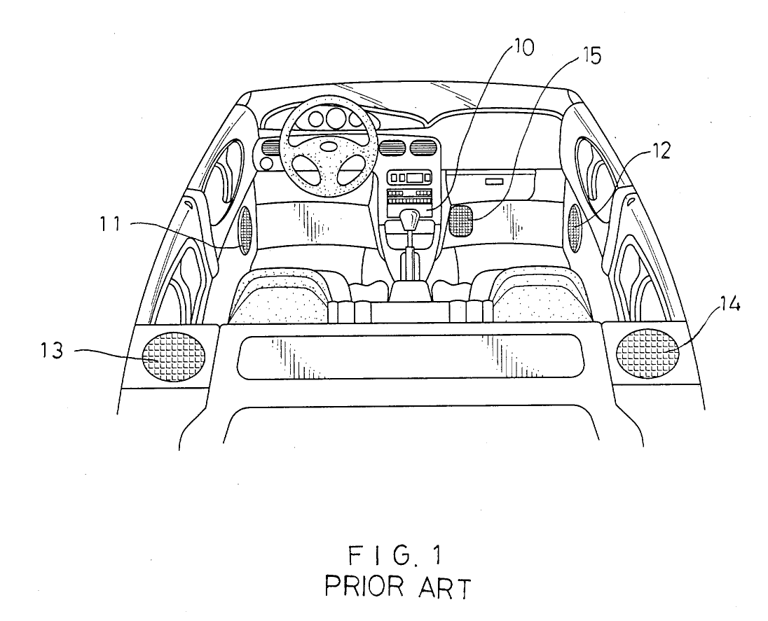

FIG. 2 is a schematic view of an embodiment of the invention.

FIG. 3 is a schematic view of a third embodiment of the invention.

FIG. 4 is a schematic side view of a third embodiment of the invention.

### DESCRIPTION OF THE PREFERRED EMBODIMENTS

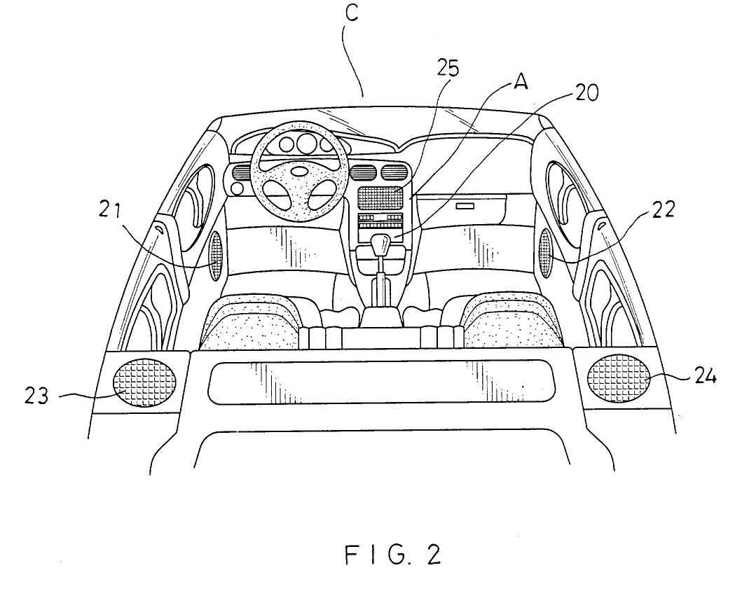

Refer to FIG. 2 for an embodiment of the invention. The multimedia car stereo system of the invention mainly includes a front left speaker 21, a front right speaker 22, a rear left speaker 23, a rear right speaker 24, a center speaker 25 and a matching car stereo host machine 20.

The car stereo host machine 20 is located on a central control station A at the front side of the car C for reading and broadcasting various types of audio sources such as CD, tape, radio broadcasting, VCD, DVD and MP3.

The front left speaker 21 is located on the left and front side of the interior of the car C and is connected to the car stereo host machine 20 to enable the car stereo host machine 20 to output sound for the left and front sound track.

The front right speaker 22 is located on the right and front side of the interior of the car C and is connected to the car stereo host machine 20 to enable the car stereo host machine 20 to output sound for the right and front sound track.

The rear left speaker 23 is located on the left and rear side of the interior of the car C and is connected to the car stereo host machine 20 to enable the car stereo host machine 20 to output sound for the left and rear sound track.

The rear right speaker 24 is located on the right and rear side of the interior of the car C and is connected to the car stereo host machine 20 to enable the car stereo host machine 20 to output sound for the right and rear sound track.

The center speaker 25 is located on the central control station A at the front side of the car C and is connected to the car stereo host machine 20 to enable the car stereo host machine 20 to output sound for the center sound track.

By means of the aforesaid structure and configuration, the center speaker 25 are built in the central control station A when the interior design of the car C is made. Therefore, it does not take additional space in the car. Other features such as the front left speaker 21, front right speaker 22, rear left speaker 23, and rear right speaker 24 are located respectively at the rear and front sides and on the left and right sides in the interior of the car C. Mating the center speaker 25, they can provide a surrounding sound effect. And car owners do not have to modify the existing stereo system or change the existing electric wiring to enjoy the sound effect in the car as in the theater.

In addition, the invention may further include a base speaker to provide the base sound track. The base speaker may be installed in the rear trunk or under the rear seat. This becomes the second embodiment of the invention.

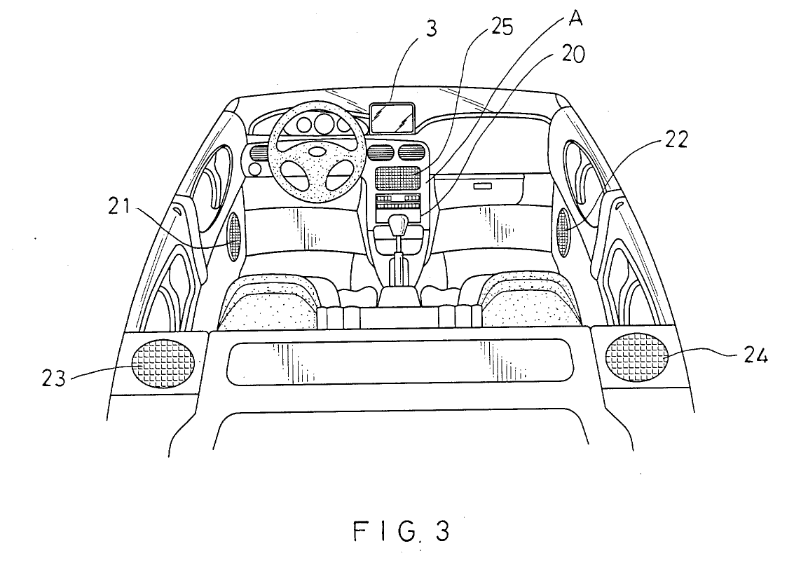

Refer to FIG. 3 for a third embodiment of the invention. It includes a flat display screen 3 and a multimedia player (not shown in the drawing) located in the car stereo host machine 20.

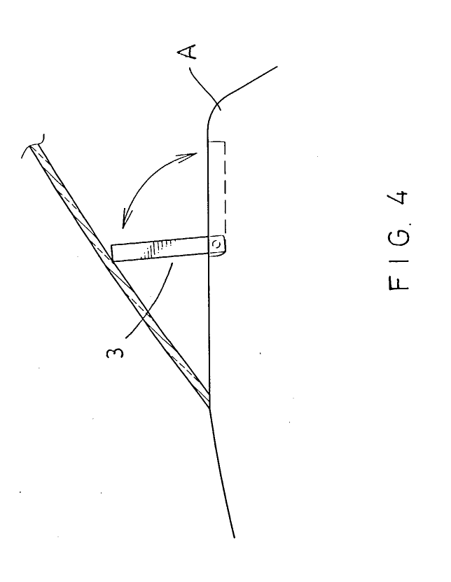

The flat display screen 3 may be a liquid crystal display device. When the flat display screen 3 is not in use, it may be hidden and stored in the central control station A without being hit incidentally (as shown in FIG. 4).

The multimedia player may be a player for broadcasting DVD and VCD films. With the audio output end connecting to the car stereo host machine 20 and the video output end connecting to the flat display screen 3, it can output multimedia pictures and sound.

By means of the construction and configuration set forth above, users can use the multimedia player to broadcast films. Coupling with the flat display screen 3, car stereo host machine 20 and the surrounding sound effect of multiple sound track speakers, a visual and audio effect like that in the theater can be enjoyed in the car.

In summary, the multimedia car stereo system of the invention integrates the interior design of the car to enable new cars shipped from the plants to provide a visual and audio effect like that in the theater without the need of modifications.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A multimedia car stereo system comprising a front left speaker, a front right speaker, a rear left speaker, a rear right speaker, a center speaker and a matching car stereo host machine, wherein:
the car stereo host machine is located on a central control station at the front side of a car for reading and broadcasting various types of audio sources;
the front left speaker is located on the left and front side of the interior of the car and connected to the car stereo host machine to allow the car stereo host machine to output sound for a left and front sound track.
the front right speaker is located on the right and front side of the interior of the car and connected to the car stereo host machine to allow the car stereo host machine to output sound for a right and front sound track;
the rear left speaker is located on the left and rear side of the interior of the car and connected to the car stereo host machine to allow the car stereo host machine to output sound for a left and rear sound track.;
the rear right speaker is located on the right and rear side of the interior of the car and connected to the car stereo host machine to allow the car stereo host machine to output sound for a right and rear sound track; and
the center speaker is located on the central control station at the front side of the car and connected to the car stereo host machine to allow the car stereo host machine to output sound for a center sound track.

2. The multimedia car stereo system of claim 1 further including a bass speaker to allow the car stereo host machine to output bass sound.

3. The multimedia car stereo system of claim 1 or 2 further having a flat display screen located in the central control station.

4. The multimedia car stereo system of claim 1 or 2, wherein the various types of audio sources read and broadcast by the car stereo host machine include CD, tapes, radio broadcasting, VCD, DVD and MP3.
